(19) United States
(12) Patent Application Publication
(10) Pub. No.: US 2013/0135419 A1
(43) Pub. Date: May 30, 2013

(54) LIGHT SCANNING APPARATUS AND IMAGE FORMING APPARATUS

(71) Applicant: CANON KABUSHIKI KAISHA, Tokyo (JP)

(72) Inventor: Yasuaki Otoguro, Abiko-shi (JP)

(73) Assignee: CANON KABUSHIKI KAISHA, Tokyo (JP)

(21) Appl. No.: 13/677,768

(22) Filed: Nov. 15, 2012

(30) Foreign Application Priority Data
Nov. 28, 2011 (JP) 2011-258648

(51) Int. Cl. B41J 2/435; G02B 26/08

(52) U.S. Cl. CPC G03G 15/04036; G02B 26/105
USPC 347/224; 359/226.2

(57) ABSTRACT

A light scanning apparatus, including: a light source; a light deflector configured to deflect a light beam emitted from the light source to scan a photosensitive member; an optical member configured to guide the light beam the photosensitive member; a housing configured to contain the light source, the light deflector, and the optical member; a cover member configured to be attached to a side wall of the housing so as to keep dust out of the light scanning apparatus; and an elastic member having a first abutment portion which is attached to the cover member and is elastically deformed by abutting the side wall, and a second abutment portion which is elastically deformed to abut the side wall according to elastic deformation of the first abutment portion when the cover member is attached to the housing.

### BACKGROUND OF THE INVENTION

1. Field of the Invention

The present invention relates to a light scanning apparatus and an image forming apparatus including the same.

2. Description of the Related Art

An image forming apparatus forms an image on a recording medium using an electrophotographic image forming process. The image forming apparatus is, for instance, an electrophotographic copier, an electrophotographic printer (e.g., a color laser beam printer, color LED printer, etc.), an MFP (multi-function printer), a facsimile machine and a word processor.

The image forming apparatus includes a light scanning apparatus. The light scanning apparatus deflects a light beam so that the light beam modulated according to image information scans a photosensitive member included in the image forming apparatus. The light beam scans the photosensitive member to form an electrostatic latent image on the photosensitive member.

FIG. 6 is a diagram illustrating optical elements of the light scanning apparatus. A light source 47 emits a light beam modulated according to image information. The light beam is brought into a parallel light beam by a collimator lens 43. The parallel light beam is condensed by a cylindrical lens 44 and enters, as a light spot, a reflecting mirror surface of a light deflector 41. The light beam deflected by the light deflector 41 passes through at least one fθ lens 45. The light beam, having thus passed through the fθ lens 45, becomes a scanning light beam moving on the surface of a photosensitive member at a constant velocity. The light beam having passed through the fθ lens 45 is imaged as a light spot moving on the photosensitive member at the constant velocity by a reflecting mirror 46.

Special lens effective surfaces, typified by an aspheric surface, have increasingly been adopted as the cylindrical lens 44 and the fθ lens 45 with a view to improving the scanning performance. A highly reflective mirror has increasingly been adopted as the reflecting mirror 46 in order to reduce a light intensity loss due to increase in image forming speed.

The light deflector 41A often adopts a configuration in which a rotary polygon mirror having many reflecting mirror surfaces on an outer circumference of the rotary polygon mirror is rotated at high speed to deflect an incident light beam in a desired direction.

The light intensity of a light beam guided onto the photosensitive member affects the image density. Unintentional variation in light intensity of the light beam causes a problem in that the density of an image formed on the recording medium is “light” or “dark”.

In particular, when dust enters the inside of the light scanning apparatus and adheres to an optical element, stains such as the dust blocks a part of the light beam to thereby reduce the image density. In recent years, air pollution has increased the amounts of dust particles with a diameter of 1 μm or less and chemicals in the atmosphere. The problem of image degradation due to stains of an optical element has been unprecedentedly serious.

Presently, a method of sealing a gap at the outer circumference of a light scanning apparatus with a foam member is often adopted. However, a light deflector, i.e., the rotary polygon mirror, arranged inside of the light scanning apparatus rotates at high speed. This rotation causes airflow. Accordingly, air sometimes flows through a portion to which the foam member is attached and a fine space continuously communicating between open-cells in the foam member. Air flows from the inside to the outside of the light scanning apparatus at a certain portion of the foam member, and from the outside to the inside of the light scanning apparatus at another portion of the foam member.

At this time, the air flowing from the outside to the inside of the light scanning apparatus includes dust particles. The longer the operating time of the light scanning apparatus, the more the amount of dust particles entering the inside of the light scanning apparatus increases and the more the amount of dust particles adhering to the surfaces of the optical elements in the light scanning apparatus and the inner surface of the housing of the light scanning apparatus increases.

In particular, the rotary polygon mirror is rotated at high speed according to increase in image forming speed. Accordingly, air-borne dust in airflow around the rotary polygon mirror easily adheres to the reflecting surfaces of the rotary polygon mirror. The rotary polygon mirror is a polygon. Accordingly, rotation of the rotary polygon mirror causes Karman's vortex street or turbulence, and the airborne dust strongly collide with the mirror surfaces. As a result, dust particles accumulate on the surface of the rotary polygon mirror. From a portion of the mirror surface with which the large amount of airflow collides, the stain begins and the reflectivity of the portion begins to decrease. The light intensity at a light spot on the surface of the image bearing member decreases, thereby causing a problem of reduction in image density.

In order to solve the problem of stains on the optical element of the light scanning apparatus, it has been proposed to provide a rubber material without open cell in a gap between a housing and a cover member.

According to a light scanning apparatus described in Japanese Patent Application Laid-Open No. 2004-262118, an elastic member formed integrally with a cover member abuts a housing to seal the light scanning apparatus.

However, in Japanese Patent Application Laid-Open No. 2004-262118, the elastic member is pressed against the housing throughout the elastic member from a proximal portion to a distal end thereof. Accordingly, if the positional accuracy between the elastic member and the housing is not very strictly controlled, a gap may occur between the elastic member and the housing. Even if the elastic member can be pressed against the housing without a gap, a large repulsive force of the elastic member may deform the housing because the elastic member is pressed against the housing from the proximal portion to the distal end thereof. Deformation of the housing degrades the optical characteristics of the light scanning apparatus.

### SUMMARY OF THE INVENTION

Thus, the present invention provides a light scanning apparatus in which the amount of deformation of a housing due to an elastic member sealing a gap between a housing and a cover member is reduced.

In order to solve the problem, a light scanning apparatus according to the present invention includes: a light source; a light deflector configured to deflect a light beam emitted from the light source so that the light beam scans a photosensitive member; an optical member configured to guide the light beam deflected by the light deflector to the photosensitive member; a housing configured to contain the light source, the light deflector, and the optical member; a cover member configured to be attached to a side wall of the housing so as to keep dust out of the light source, the light deflector, and the optical member; and an elastic member including a first abutment portion which is attached to the cover member and is elastically deformed by abutting the side wall when the cover member is attached to the housing, and a second abutment portion which is provided along the side wall in a state in which the cover member is attached to the side wall, and is elastically deformed toward the side wall according to elastic deformation of the first abutment portion so as to abut the side wall.

Further features of the present invention will become apparent from the following description of exemplary embodiments with reference to the attached drawings.

### BRIEF DESCRIPTION OF THE DRAWINGS

FIGS. 1A, 1B and 1C are diagrams illustrating an elastic member according to an embodiment.

FIGS. 2A, 2B and 2C are diagrams illustrating a light scanning apparatus according to the embodiment.

FIGS. 3A and 3B are diagrams illustrating a fixing member configured to fix a cover member to a housing.

FIGS. 4A, 4B, 4C and 4D are diagrams for illustrating deformation of the elastic member.

FIG. 5 is a diagram illustrating an image forming apparatus according to the embodiment.

FIG. 6 is a diagram illustrating optical elements of the light scanning apparatus.

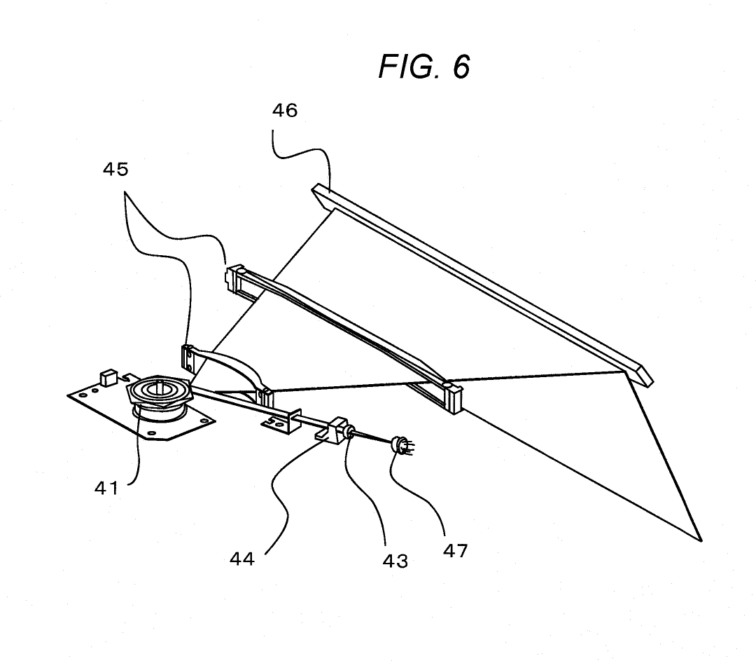

### DESCRIPTION OF THE EMBODIMENTS

Preferred embodiments of the present invention will be described in detail in accordance with the accompanying drawings.

(Image Forming Apparatus)

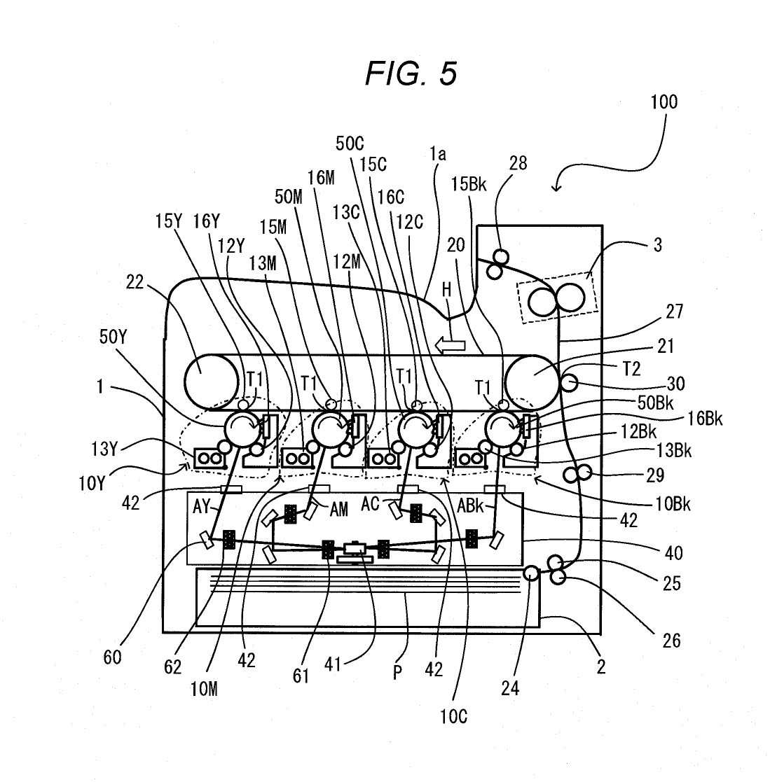

FIG. 5 is a diagram illustrating an image forming apparatus 100 according to the embodiment. A tandem-type color laser beam printer will be described as an example of the image forming apparatus 100.

The image forming apparatus 100 includes an image forming portion including four image forming units 10 (10Y, 10M, 10C and 10Bk). The image forming unit 10Y forms a yellow toner image. The image forming unit 10M forms a magenta toner image. The image forming unit 10C forms a cyan toner image. The image forming unit 10Bk forms a black toner image.

The image forming units 10 include respective photosensitive drums (image bearing members) 50 (50Y, 50M, 50C and 50Bk) as photosensitive members. Each image forming unit 10 includes a charging roller 12, a developing device 13, a primary transfer roller 15, and a cleaning device 16, which are arranged around the photosensitive drum 50.

The developing device 13 (13Y, 13M, 13C and 13Bk) contains a dual-component developer in which a toner and a carrier are mixed. The developing devices 13Y, 13M, 13C and 13Bk contain yellow toner, magenta toner, cyan toner and black toner, respectively.

An intermediate transfer belt 20 is disposed above the image forming units 10 in contact with the photosensitive drums 50. The intermediate transfer belt 20 is an endless belt. The intermediate transfer belt 20 passes over a pair of belt conveyance rollers 21 and 22, and is rotated in the direction indicated by an arrow H. The intermediate transfer belt 20 is in contact with the photosensitive drums 50 by the respective primary transfer rollers 15 (15Y, 15M, 15C and 15Bk), thereby forming primary transfer portions T1.

The secondary transfer roller 30 is arranged opposite to the belt conveyance roller 21 with the intermediate transfer belt 20 being interposed between the secondary transfer roller 30 and the belt conveyance roller so that a secondary transfer portion T2 is formed between the secondary transfer roller 30 and intermediate transfer belt 20.

The four image forming units 10 are arranged in parallel below the intermediate transfer belt 20. The four image forming units 10 are arranged in an order of the yellow image forming unit 10Y, the magenta image forming unit 10M, the cyan image forming unit 10C, and the black image forming unit 10Bk along the rotational direction H of the intermediate transfer belt 20.

A light scanning apparatus 40 is arranged below the four image forming units 10. The light scanning apparatus 40 emits light beams modulated according to pieces of color image information, to the respective photosensitive drums 50 of the image forming units 10. One light scanning apparatus 40 is shared by the four image forming units 10.

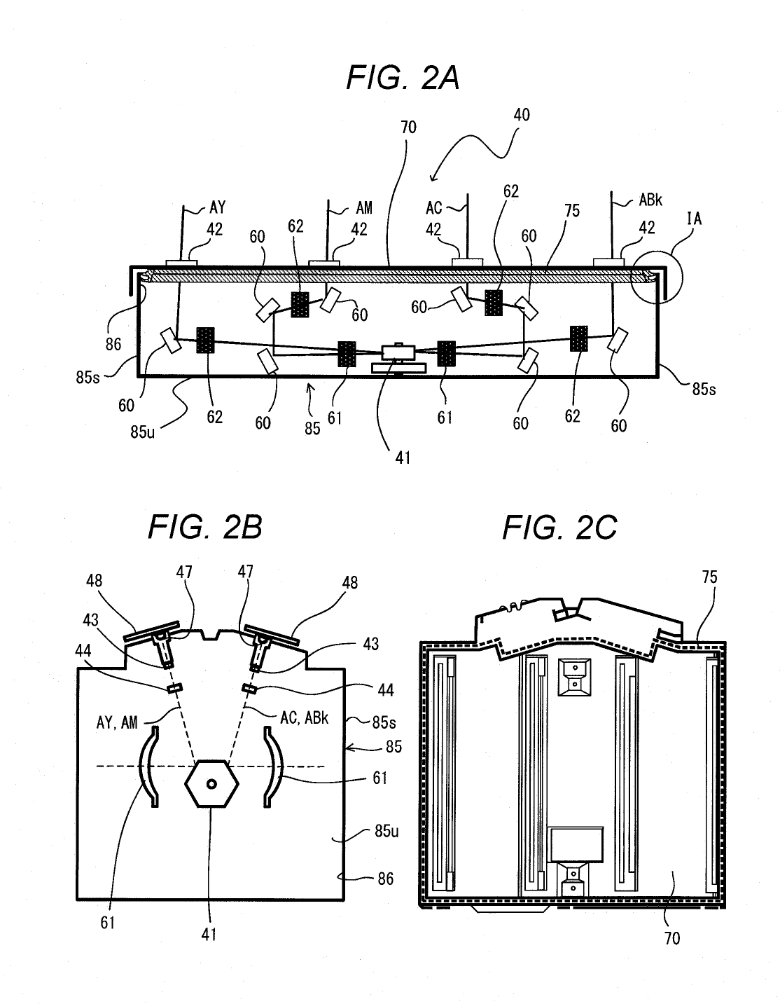

The light scanning apparatus 40 includes four light sources (semiconductor lasers) 47 (FIG. 2B), a light deflector (polygon motor unit) 41, a reflecting mirror 60, a first imaging lens 61 and a second imaging lens 62. The four light sources 47 emit light beams (laser light) A (AY, AM, AC and ABk) modulated according to the respective pieces of color image information. The light deflector 41 is rotated at high speed to deflect and scan the light beams A. The light beams A are guided by the reflecting mirrors 60, the first imaging lenses 61 and the second imaging lenses 62 and irradiate the respective photosensitive drums 50 through respective irradiation windows 42 provided at the upper portion of the light scanning apparatus 40. The light beams A are scanned along the axial direction (main scanning direction) of the respective photosensitive drums 50.

The paper feed cassette 2 is arranged in the lower portion of an apparatus main body 1 of the image forming apparatus 100 and below the light scanning apparatus 40. The paper feed cassette 2 is detachably attached to the apparatus main body 1 from a side of the apparatus main body 1. The paper feed cassette 2 contains a recording medium (hereinafter referred to as a sheet) P. The sheet P is picked up one by one by a pick-up roller 24, and fed by a feed roller 25. A retard roller 26 is arranged opposite to the feed roller 25 to prevent double feed of the sheets P.

The sheet conveyance path 27 is provided substantially vertically along the right side of the apparatus main body 1. The sheet P is fed from the paper feed cassette 2 and is conveyed along the sheet conveyance path 27 through a pair of registration rollers 29 and the secondary transfer portion T2 to the fixing device 3. The fixing device 3 is arranged immediate above the secondary transfer portion T2.

(Image Forming Operation)

An image forming operation will be described below. The photosensitive drum 50 is rotated in a direction (clockwise direction) indicated by an arrow in FIG. 5 in synchronization with rotation in the direction (counterclockwise direction) indicated by the arrow H of the intermediate transfer belt 20. The surfaces of the photosensitive drums 50 are uniformly charged by the respective charging rollers 12 (12Y, 12M, 12C and 12Bk).

The light scanning apparatus 40 irradiates the uniformly charged surface of the photosensitive drum 50Y with the light beam AY modulated according to yellow image information to form an electrostatic latent image for a yellow image on the photosensitive drum 50Y. Likewise, the light scanning apparatus 40 irradiates the uniformly charged surface of the photosensitive drum 50M with the light beam AM modulated according to magenta image information to form an electrostatic latent image for a magenta image on the photosensitive drum 50M. Likewise, the light scanning apparatus 40 irradiates the uniformly charged surface of the photosensitive drum 50C with the light beam AC modulated according to cyan image information to form an electrostatic latent image for a cyan image on the photosensitive drum 50C. Likewise, the light scanning apparatus 40 irradiates the uniformly charged surface of the photosensitive drum 50Bk with the light beam ABk modulated according to black image information to form an electrostatic latent image for a black image on the photosensitive drum 50Bk.

The developing devices 13 (13Y, 13M, 13C and 13Bk) develop the respective electrostatic latent images on the photosensitive drums 50 with the respective colors of toner to form a yellow toner image, a magenta toner image, a cyan toner image, and a black toner image.

A predetermined transfer bias voltage is applied to primary transfer rollers 15 (15Y, 15M, 15C and 15Bk) to form electric fields at the respective primary transfer portions T1 between the photosensitive drums 50 and the primary transfer rollers 15. The respective color toner images on the photosensitive drums 50 are primarily transferred onto the intermediate transfer belt 20 by coulomb forces in a sequential manner so as to be superimposed on top of each other.

The cleaning devices 16 (16Y, 16M, 16C and 16Bk) remove the toner remaining on the respective photosensitive drums 50 after the primary transfer.

The pick-up roller 24 picks up the sheet P in the paper feed cassette 2. The feed roller 25 feeds the sheet P to the pair of registration rollers 29. The sheet P temporarily stops at the pair of registration rollers 29. The pair of registration rollers 29 conveys the sheet P to the secondary transfer portion T2 in synchronization with the superimposed toner images on the intermediate transfer belt 20.

At the secondary transfer portion T2, the superimposed toner images on the intermediate transfer belt are secondarily transferred onto the sheet P collectively.

The sheet P on which the toner images have been transferred is conveyed to the fixing device 3 along the sheet conveyance path 27. The fixing device 3 applies heat and pressure to the sheet P and fixes the toner images on the sheet P to form a full color image.

The sheet P on which the full color image is formed is discharged by the discharge roller 28 onto a discharge tray la provided on the upper portion of the apparatus main body 1.

(Light Scanning Apparatus)

Next, the light scanning apparatus 40 will be described.

FIGS. 2A, 2B and 2C are diagrams illustrating light scanning apparatus 40 according to the embodiment. FIG. 2A is a longitudinal sectional view of the light scanning apparatus 40. FIG. 2B is a diagram illustrating an incident optical system contained in a housing 85.

The light scanning apparatus 40 includes the light sources 47, the light deflector 41, the imaging optical elements (optical members) (60, 61, and 62), the housing 85, a cover member 70, and an elastic member 75. The housing 85 of the light scanning apparatus 40 contains the light sources 47, the light deflector 41, and the imaging optical elements (60, 61, and 62). The housing 85 includes a bottom wall 85u, a side wall 85s, and an opening 86 defined by the side wall 85s.

As illustrated in FIG. 2B, two light source units are attached to the side wall 85s of the housing 85. Each of the light source units 48 includes the two light sources 47 arranged side-by-side vertically (in a sub-scanning direction). The light sources 47 emit light beams (laser light) A (AY, AM, AC, and ABk). The light beams A enter the light deflector 41 through the collimator lenses 43 and the cylindrical lenses 44. The light deflector 41 deflects the light beams A from the light sources 47.

The imaging optical elements (60, 61, and 62) image the light beams deflected by the light deflector 41 onto the surfaces (scanned surfaces) of the photosensitive drums 50. The imaging optical elements (60, 61, and 62) include the first imaging lenses 61 and the second imaging lenses 62 configured to image the light beams onto the photosensitive drums 50, and the reflecting mirrors 60 guiding the light beams to the photosensitive drums 50.

The light deflector 41 and the imaging optical elements (60, 61, and 62) are put in the housing 85 through the opening 86 of the housing 85. The cover member 70 covers the opening 86 of the housing 85.

The elastic member 75 is disposed between the side wall 85s of the housing 85 and the cover member 70, and functions as a sealing member, which seals a gap between the housing 85 and the cover member 70. FIG. 2C is a diagram illustrating the underside of the cover member 70. The elastic member 75 is continuously provided substantially along the edge of the underside of the cover member 70 as indicated by a broken line in FIG. 2C.

(Elastic Member)

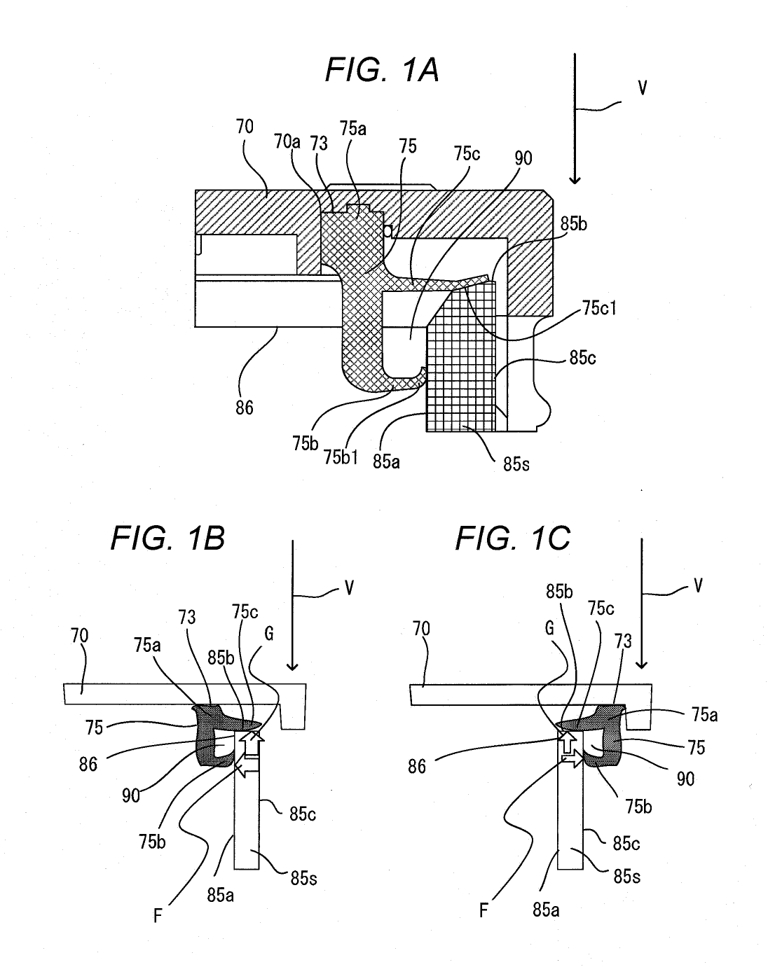

Hereinafter, referring to FIGS. 1A, 1B and 1C, the elastic member 75 will be described. FIGS. 1A, 1B and 1C are diagrams illustrating the elastic member 75 according to one embodiment. FIG. 1A is an enlarged diagram of a encircled portion IA in FIG. 2A.

The elastic member 75 is continuous and endlessly closed. The elastic member 75 is attached to the cover member 70 by a connection portion (attachment portion) 73. The proximal portion of the elastic member 75 configures an attachment portion 75a to be attached to the cover member 70. The attachment portion 70a of the cover member 70 to which the elastic member 75 is attached is continuously provided substantially along the edge of the underside of the cover member 70.

At the connection portion 73, the attachment portion 75a of the elastic member 75 is attached to the attachment portion 70a of the cover member 70. The elastic member 75 may be connected to the cover member 70 by a fixing means such as adhesive. Instead, in the embodiment, the elastic member 75 is molded integrally with the cover member 70.

The elastic member 75 may be molded integrally with the cover member 70 by two-color molding. Instead, after the cover member 70 is formed, the cover member 70 may be set in another mold again and the elastic member 75 may additionally be molded.

As the elastic member 75 is thus molded integrally with the cover member 70, the operability of assembling the light scanning apparatus 40 can be significantly improved in comparison with a conventional method of manually pasting the elastic member onto the cover member.

In the embodiment, the elastic member 75 is connected to the cover member 70 in the connection portion 73. However, the present invention is not limited thereto. For instance, the elastic member 75 may be inserted into a groove extending along the edge of the cover member 70 so as to be attached to the cover member 70.

The cover member 70 is attached to the housing 85 in an attaching direction indicated by an arrow V in FIG. 1A. The connection portion 73 between the elastic member 75 and the cover member 70 is offset from the side wall 85s to the inside of the opening 86 of the housing 85 as viewed in the attaching direction V in which the cover member 70 is attached to the housing 85. Because the elastic member 75 is disposed inside the housing 85, the light scanning apparatus 40 can be reduced in size.

A portion of the elastic member 75 is configured to be brought into contact with the housing 85 when the cover member 70 is attached to the housing 85.

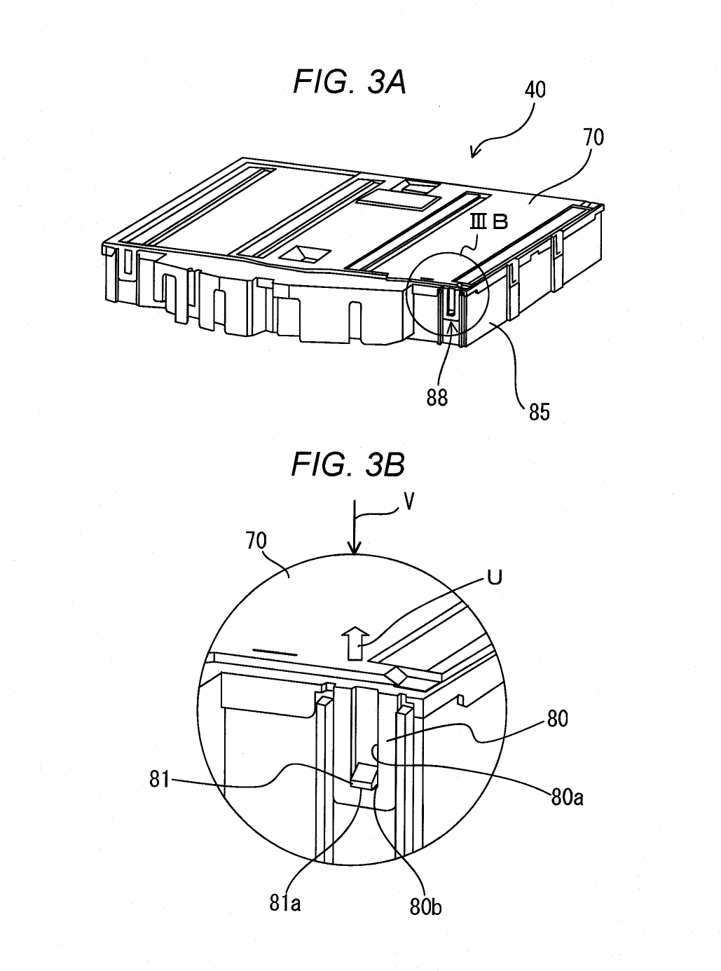

FIGS. 3A and 3B are diagrams illustrating a fixing member 88 configured to fix the cover member 70 to the housing 85. FIG. 3A is a perspective view of the light scanning apparatus 40. FIG. 3B is an enlarged diagram of an encircled portion IIIB in FIG. 3A.

The fixing member 88 includes a snap fit member provided on the cover member 70 and a protrusion 81 provided on the housing 85. The cover member 70 is attached to the housing 85 in the attaching direction V so as to cover the opening 86 of the upper portion of the housing 85. The snap fit member 80 of the cover member 70 climbs over the protrusion 81 of the housing 85 and the protrusion 81 is fitted into the groove 80a of the snap fit member 80. The cover member 70 is fixed to the housing 85 so as not to be dropped from the housing 85, by engagement between the snap fit member 80 and the protrusion 81.

The cover member 70 is pressed in a direction (direction indicated by the arrow U) toward the top surface of the cover member 70 by a repulsive force of the elastic member 75. The repulsive force of the elastic member 75 causes a positioning surface 80b of the snap fit member 80 to abut a positioning surface 81a of the protrusion 81. Thus, the cover member 70 is accurately positioned with respect to the housing 85.

The elastic member 75 includes a first abutment portion 75c and a second abutment portion 75b which at least bifurcate from the attachment portion (proximal portion) 75a and extending in at least two directions in a vertical sectional view. The first abutment portion 75c and the second abutment portion 75b are flange portions (protruding edges) extending along the attachment portion 75a of the elastic member 75. When the elastic member 75 is disposed between the side wall 85s of the housing 85 and the cover member 70, the first abutment portion 75c and the second abutment portion 75b extend along the side wall 85s of the housing 85.

The first abutment portion 75c and the second abutment portion 75b branch from the attachment portion 75a so that the second abutment portion 75b is deformed according to a deformation of the first abutment portion 75c.

The first abutment portion 75c comes into contact with the side wall 85s so as to be elastically deformed when the cover member 70 is attached to the housing 85. The second abutment portion 75b is provided so as to extend along the side wall 85s in a state in which the cover member 70 is attached to the side wall 85s so that the second abutment portion 75b is elastically deformed according to the deformation of the first abutment portion 75c so as to come into contact with the side wall 85s.

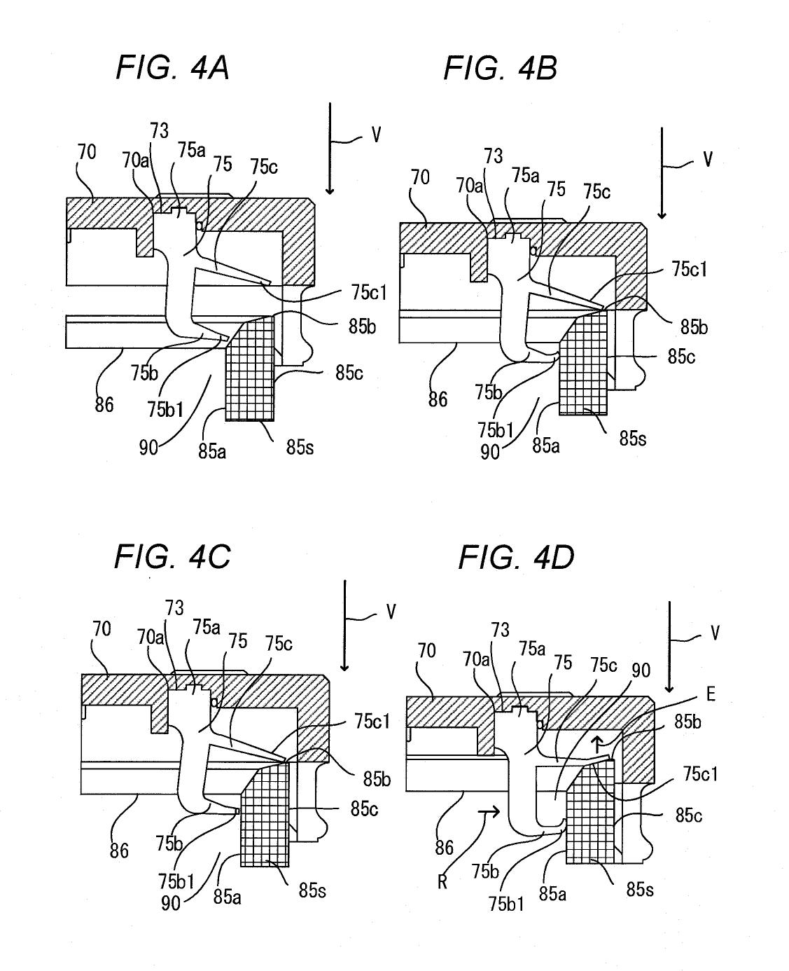

Hereinafter, referring to FIGS. 4A, 4B, 4C and 4D, deformation of the first abutment portion 75c and the second abutment portion 75b will be described.

FIGS. 4A, 4B, 4C and 4D are diagrams illustrating deformation of the elastic member 75. FIG. 4A is a diagram illustrating a state in which the elastic member 75 is out of contact with the side wall 85s of the housing 85 before the cover member 70 is attached to the housing 85. FIGS. 4B and 4C are diagrams illustrating a state in which the elastic member 75 is in contact with the side wall 85s of the housing 85 while the cover member 70 is being attached to the housing 85. FIG. 4D is a diagram illustrating the elastic member 75 after the cover member 70 has been attached to the housing 85.

In order to attach the cover member 70 to the housing 85, as illustrated in FIG. 4A, the cover member 70 is moved toward the housing 85 in the direction indicated by the arrow V.

As illustrated in FIG. 4B, the second abutment portion 75b of the elastic member 75 is in contact with the inner wall surface 85a of the side wall 85s of the housing 85, and the distal end 75b1 of the second abutment portion 75b is deformed so as to ride up as the elastic member 75 is moved in the direction indicated by the arrow V. The distal end 75c1 of the first abutment portion 75c of the elastic member 75 comes into contact with the top surface 85b of the side wall 85s of the housing 85.

In the state in which the distal end 75c1 of the first abutment portion 75c is in contact with the top surface 85b of the side wall 85s, the distal end 75b1 of the second abutment portion 75b is not necessarily in contact with the inner wall surface 85a of the side wall 85s, as illustrated in FIG. 4C.

When the cover member 70 is further moved toward the housing 85 in the direction indicated by the arrow V, the distal end 75c1 of the first abutment portion 75c is pressed by the top surface 85b of the side wall 85s to be deformed in the direction indicated by the arrow E. The deformation of the first abutment portion 75c rotates the attachment portion 75a of the elastic member 75 about the connection portion 73, and deforms the second abutment portion 75b in a direction indicated by an arrow R. That is, the second abutment portion 75b is deformed toward the first abutment portion 75c according to the deformation of the first abutment portion 75c. Accordingly, the distal end 75b1 of the second abutment portion 75b is elastically deformed toward the inner wall surface 85a of the side wall 85s to press the inner wall surface 85a. In other words, the second abutment portion 75b is elastically deformed to abut the inner wall surface 85a.

When the cover member 70 is attached to the housing 85, the distal end 75b1 of the second abutment portion 75b is brought into contact with the inner wall surface 85a of the housing 85 so that the second abutment portion 75b is deformed. In FIG. 1A, the distal end 75b1 of the second abutment portion 75b is in contact with the inner wall surface 85a in the state of riding up. Instead, the contact may be made so that the distal end 75b1 is in contact with the inner wall surface 85a so as to be bent smoothly into a curve or bent sharply. As to the first abutment portion 75c, the side portion of the distal end 75c1 of the first abutment portion 75c is in contact with the top surface 85b of the housing 85.

The first abutment portion 75c and the second abutment portion 75b press different surfaces 85a and 85b of the housing 85 in different directions.

The attachment portion (proximal portion) 75a of the elastic member 75 is disposed inside the opening 86 of the housing 85 as viewed in the attaching direction V in which the cover member 70 is attached to the housing 85. That is, in a plane perpendicular to the inner wall surface 85a of the housing 85 pressed by the second abutment portion 75b of the elastic member 75, the connection portion 73 of the cover member 70 and the elastic member 75 are positioned more inside of the light scanning apparatus 40 than the inner wall surface 85a pressed by the second abutment portion 75b. Accordingly, the elastic member 75 can be positioned more inside than the outer wall surface 85c of the housing 85. Thus, downsizing of the light scanning apparatus 40 can be achieved.

The distal end 75b1 of the second abutment portion 75b presses the inner wall surface 85a of the side wall 85s of the housing 85 in the direction perpendicular to the attaching direction V. The distal end 75b1 of the second abutment portion 75b receives a repulsive force F from the inner wall surface 85a of the side wall 85s in the direction perpendicular to the attaching direction V.

Meanwhile, the side portion of the distal end 75c1 of the first abutment portion 75c presses the top surface 85b of the side wall 85s of the housing 85 in the attaching direction V. The side portion of the distal end 75c1 of the first abutment portion 75c receives a repulsive force G from the top surface 85b of the side wall 85s in a direction opposite to the attaching direction V.

As illustrated in FIG. 1B, the elastic member 75 is deformed so as to be balanced with the repulsive force F of the inner wall surface 85a and the repulsive force G of the top surface 85b of the housing 85, and maintained at a stable position. The elastic member 75 can generate the repulsive force G toward the cover member 70 in a direction other than the direction away from the housing 85 due to the repulsive force F. Accordingly, a stable seal performance can be secured. Thus, the elastic member 75 can deliver a high seal performance and a stable seal performance.

In a state in which the elastic member 75 is disposed with respect to the housing 85 so that the first abutment portion 75c and the second abutment portion 75b of the elastic member 75 press the inner wall surface 85a and the top surface 85b of the housing 85, respectively, the elastic member 75 and the housing 85 form an enclosed space 90 between the second abutment portion 75b and the first abutment portion 75c. As the enclosed space 90 is provided, the flexibility of the elastic member 75 can be sufficiently delivered. In the state in which the flexibility of the elastic member 75 is sufficiently provided, the elastic member 75 can securely seal between the cover member 70 and the housing 85. Accordingly, degradation in optical characteristics, such as variation in irradiation position due to deformation of the housing 85, can be prevented.

Even if long time use of the light scanning apparatus 40 increases the temperature of the light scanning apparatus to deform the housing 85, the elastic member 75 of the embodiment can securely seal between the cover member 70 and the housing 85 by flexible deformation of the first abutment portion 75c and the second abutment portion 75b. Accordingly, even if temperature varies between inside and outside of the light scanning apparatus 40, the elastic member 75 can prevent dust particles from entering between the cover member 70 and the housing 85. Therefore, stain on the optical elements provided in the light scanning apparatus 40 can be avoided.

In the embodiment, the direction of the repulsive force F toward the second abutment portion 75b of the elastic member 75 is perpendicular to the direction of the repulsive force G toward the first abutment portion 75c. Accordingly, the directions of the pressing forces exerted on the housing 85 by the elastic member 75 can be orthogonal to each other. Therefore, the amount of deformation of the housing 85 caused by the elastic member can be reduced. Thus, the elastic member 75 of the embodiment can significantly reduce degradation of the optical characteristics of the optical element, which is conventionally caused by deformation of the housing owing to the pressing force of the elastic member.

In the embodiment, the direction of the pressing force exerted on the housing 85 by the second abutment portion 75b of the elastic member 75 is perpendicular to the direction of the pressing force exerted on the housing 85 by the first abutment portion 75c. However, the present invention is not limited thereto. The direction of the pressing force exerted on the housing 85 by the second abutment portion 75b of the elastic member 75 may be different from the direction of the pressing force exerted on the housing 85 by the first abutment portion 75c. The pressing forces exerted on the housing 85 by the elastic member 75 are thus distributed in two directions orthogonal to each other so that the amount of deformation of the housing 85 caused by the elastic member 75 can be reduced.

In the embodiment, the elastic member 75 is formed integrally with the cover member 70. However, the elastic member 75 may be formed integrally with the housing 85. In the case where the elastic member 75 is formed integrally with the housing 85, the abutment portions provided on the elastic member 75 are configured to press different surfaces of the cover member 70 in different directions. Even such a modification of the embodiment can produce the technical effects analogous to those of the embodiment.

In the embodiment, the connection portion 73 between the elastic member 75 and the cover member 70 is offset from the side wall 85s and positioned inside the opening 86 of the housing 85 as viewed from the attaching direction V in which the cover member 70 is attached to the housing 85. However, the present invention is not limited thereto. As illustrated in FIG. 1C, the connection portion 73 between the elastic member 75 and the cover member 70 may be offset from the side wall 85s and positioned outside the opening 86 of the housing 85 as viewed from the attaching direction V in which the cover member 70 is attached to the housing 85. In this case, the second abutment portion 75b is in contact with the outer wall surface 85c of the side wall 85s. The first abutment portion 75c and the second abutment portion 75b press the different surfaces 85a and 85c of the side wall 85s of the housing 85 in different directions. The embodiment illustrated in FIG. 1C can also produce a sealing effect analogous to that of the embodiment illustrated in FIG. 1B.

According to the embodiment, the amount of deformation of the housing 85 can be reduced. Accordingly, the light scanning apparatus 40 can reproduce the electrostatic latent image on the photosensitive drum 50 with high accuracy to form a high quality image.

According to the embodiment, stains on the optical element caused by fine dust particles can be avoided. Therefore, the light intensity of the light beam for forming an electrostatic latent image can be stably maintained at a desired value. According to the embodiment, the dustproof performance of the light scanning apparatus 40 can be improved.

In the embodiment, the elastic member 75 includes the first abutment portion 75c and the second abutment portion 75b. However, the present invention is not limited thereto. The distal end of the elastic member 75 may be divided in at least two directions. The divided portions may be in contact with different portions of the housing or the cover member to press them in different directions.

According to the embodiment, the elastic member forms the enclosed space 90 so as to sufficiently provide the flexibility of the elastic member 75. Accordingly, this member is hardly affected by the accuracy of the attachment position of the elastic member 75, thereby providing the secure sealing between the housing and the cover member.

According to the embodiment, the amount of deformation of the housing caused by the elastic member, which seals between the housing and the cover member, can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-258648, filed Nov. 28, 2011, which is hereby incorporated by reference herein in its entirety.

What is claimed is:

1. A light scanning apparatus, comprising:
a light source;
a light deflector configured to deflect a light beam emitted from the light source so that the light beam scans a photosensitive member;
an optical member configured to guide the light beam deflected by the light deflector to the photosensitive member;
a housing configured to contain the light source, the light deflector, and the optical member;
a cover member configured to be attached to a side wall of the housing so as to keep dust out of the light source, the light deflector, and the optical member; and
an elastic member having a first abutment portion which is attached to the cover member and is elastically deformed by abutting the side wall when the cover member is attached to the housing, and a second abutment portion which is provided along the side wall in a state in which the cover member is attached to the side wall, and is elastically deformed toward the side wall according to elastic deformation of the first abutment portion so as to abut the side wall.

2. A light scanning apparatus according to claim 1, wherein the first abutment portion abuts a top surface of the side wall, and the second abutment portion abuts an inner wall surface or an outer wall surface of the side wall.

3. A light scanning apparatus according to claim 1, wherein the elastic member is formed integrally with the cover member.

4. A light scanning apparatus according to claim 1, wherein the elastic member and the housing form an enclosed space between the first abutment portion and the second abutment portion.

5. A light scanning apparatus according to claim 1, wherein the elastic member is positioned inside of an opening of the housing as viewed in an attaching direction in which the cover member is attached to the housing.

6. An image forming apparatus, comprising:
a photosensitive member; and
a light scanning apparatus configured to irradiate a surface of the photosensitive member with a light beam, the light scanning apparatus including:
a light source;
a light deflector configured to deflect the light beam emitted from the light source so that the light beam scans the photosensitive member;
an optical member configured to guide the light beam deflected by the light deflector to the photosensitive member;
a housing configured to contain the light source, the light deflector, and the optical member;
a cover member configured to be attached to a side wall of the housing so as to keep dust out of the light source, the light deflector, and the optical member; and
an elastic member having a first abutment portion which is attached to the cover member and is elastically deformed by abutting the side wall when the cover member is attached to the housing, and a second abutment portion which is provided along the side wall in a state in which the cover member is attached to the side wall, and is elastically deformed toward the side wall according to elastic deformation of the first abutment portion so as to abut the side wall.
